(19) United States
(12) Patent Application Publication
(10) Pub. No.: US 2012/0271541 A1
(43) Pub. Date: Oct. 25, 2012

(54) ROUTE RECOMMENDATION SYSTEM

(75) Inventors: Johan HJELM, Tokyo (JP); Mattias LIDSTRÖM, Stockholm (SE); Mona MATTI, Nacka (SE)

(73) Assignee: TELEFONAKTIEBOLAGET L M ERICSSON (PUBL), Stockholm (SE)

(21) Appl. No.: 13/090,554

(22) Filed: Apr. 20, 2011

(51) Int. Cl. G01C 21/00

(52) U.S. Cl. 701/410; 701/439

(57) ABSTRACT

A recommendation apparatus for determining, for a user, a set of one or more recommended routes going from a starting location to an ending location in response to receiving from the user a route request message identifying the starting and ending locations. Advantageously, in some embodiments, the route recommender apparatus determines a recommended route by analyzing a set of routes between the starting and ending locations, where each route in the set was traversed by a person who is in a “social graph” belonging to the user (e.g., each route in the set was traversed by one of the user's Facebook friends). In this way, routes can be recommended to the user based on routes that are popular with the user's friends.

### TECHNICAL FIELD

The invention relates to the field of route recommendations.

### BACKGROUND

For any given route from a first location to a second location, there usually exists a number of acceptable alternative routes. For example, consider a person (e.g., Johan) who lives in an apartment building and walks to a nearby train station each morning as part of his daily commute to work. Johan may have several acceptable routes to choose from when walking to the train station. If we assume Johan has only recently moved to the apartment building, Johan may not realize that alternative routes to the train station exist. Moreover, even if he is aware of these alternative routes, he may not realize that some of these routes have certain advantages over the route he usually takes each morning.

What is desired, therefore, are systems and methods for providing route recommendations.

### SUMMARY

A novel route recommendation apparatus and method is described herein. The route recommendation apparatus, at least in some embodiments, functions to determine, for a user, a set of one or more recommended routes going from a starting location to an ending location in response to receiving from the user a route request message identifying the starting and ending locations. Advantageously, in some embodiments, the route recommender apparatus determines a recommended route by analyzing a set of routes between the starting and ending locations, where each route in the set was traversed by a person who is in a “social graph” belonging to the user (e.g., each route in the set was traversed by one of the user's Facebook friends). In this way, routes can be recommended to the user based on routes that are popular with the user's friends. If a user were to follow such a recommended route, the probability that the user will run into a friend or an object a friend found interesting will likely be higher than if the user selected a route using some other criteria.

Accordingly, in one aspect, a route recommender apparatus for recommending a route to a user is provided. In some embodiments, the route recommender apparatus includes a data storage system for storing, for each of a plurality of persons, location information associated with the person, where the location information may include information identifying places that the person has previously visited or passed through. The route recommender apparatus also includes a network interface for receiving route request messages. The route recommender apparatus further includes a data processing system configured to perform a route recommendation method in response to the network interface receiving a route request message that was transmitted by a communication device operated by a user, where the route request message requests a recommended route from a first location to a second location.

In some embodiments, this route recommendation method includes the steps of: (a) determining a recommended route going from the first location to the second location, wherein the determining step comprises using at least some of the stored location information in determining the recommended route; and (b) using the network interface to transmit to the communication device a route request response message comprising information identifying the determined recommended route. The information identifying the determined recommended route may include information identifying recommended places to visit—i.e., points-of-interest. The information identifying the recommended places to visit may include information identifying an implicit or explicit rating one of the plurality of persons gave to one of the recommended places to visit.

In some embodiments, the method further includes determining a set of persons who are in a social graph belonging to the user, and the step of using at least some of the stored location information in determining the recommended route comprises using only stored location information that is associated with a person who is in the user's social graph in determining the recommended route.

In some embodiments, the location information associated with one of the plurality of persons includes information identifying places the person has previously visited and may further include the time at which the person visited those places. The location information associated with the one of the plurality of persons may further include rating information identifying a rating the person gave to one of the places the person visited. In some embodiments, the step of using at least some of the stored location information in determining the recommended route includes using the information identifying a route going from the first location to the second location traversed by said person and the rating information.

In some embodiments, the location information associated with one of the plurality of persons further includes time information identifying a time of day at which the person traversed the route. In such embodiments, the method may further include determining the current time of day, and the step of using at least some of the stored location information in determining the recommended route comprises using the time information and the determined current time of day in determining the recommended route.

In some embodiments, the data storage system is operable to store preference information belonging to the user, and the step of determining the recommended route further comprises using the preference information in determining the recommended route.

In another aspect, a route recommendation method for recommending a route to a user is provided. In some embodiments, the route recommendation method includes the step of, for each of a plurality of persons, storing location information associated with the person, where the location information includes information identifying places that the person has previously visited or passed through. The method also includes the step of receiving, at a server, a route request message transmitted from a communication device operated by the user, where the route request message requests a recommended route from a first location to a second location. The method further includes the step of determining a recommended route going from the first location to the second location in response to receiving to receiving the route request message. This determining step includes using at least some of the stored location information in determining the recommended route. The method also includes the step of transmitting, from the server and to the communication device, a route request response message comprising information identifying the determined recommended route.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 illustrates a system that includes a novel route recommender apparatus.

FIG. 2 is a functional block diagram of an exemplary route recommendation apparatus.

FIG. 3 illustrates an exemplary data structure that may be maintained and used by a route recommender apparatus.

FIG. 4 illustrates an example user interface for displaying a recommended route.

FIG. 5 is a flow chart illustrating a processes according to an embodiment.

FIG. 6 is a flow chart illustrating a processes according to an embodiment.

FIG. 7 is a block diagram of a particular embodiment of a route recommender apparatus.

FIG. 8 is a block diagram illustrating example software components of a route recommender apparatus.

### DETAILED DESCRIPTION

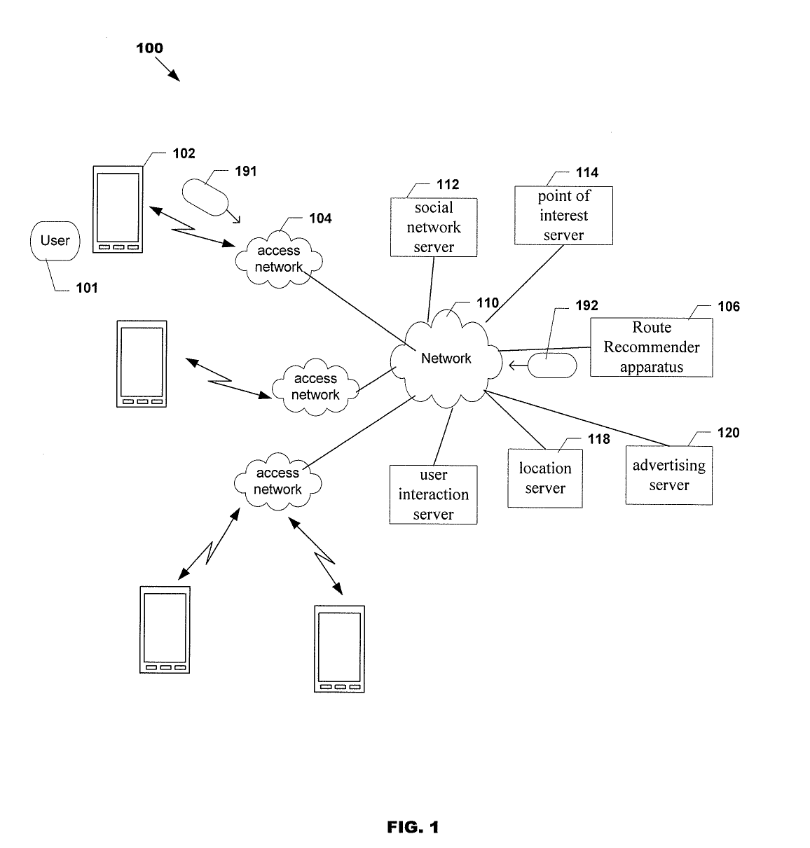

Referring now to FIG. 1, FIG. 1 illustrates a system 100 in which a user 101 of a communication device (e.g., mobile terminal, desktop computer, or other device capable of transmitting and receiving data via a network 110) can receive a personalized route recommendation from a route recommender apparatus 106, which may comprise one or more servers. For example, user 101 can use communication device to send to a route recommender apparatus 106 a route request message 191, which requests route recommender apparatus 106 to provide a recommend route from a first location to a second location. In response to receiving route request message 191, route recommender apparatus 106 may determine a recommended route going from the first location to the second location and transmit to the user's communication device 102 a route request response message 192, which includes route information identifying (directly or indirectly) the determined recommended route. For example, the route information my indirectly identify the determined route by comprising information (e.g., uniform resource locator (URL)) identifying a web page (or other data set) that includes information directly identifying the determined recommended route.

In determining the recommended route for user 101 in response to receiving route request message 191, route recommender apparatus 106 may use, for each of a plurality of persons, stored location information associated with the person. The stored location information may identify one or more routes the person has traversed within the last X days, weeks, months, where X>0. Advantageously, in some embodiments, route recommender apparatus 106 determines a recommended route by: (a) determining a set of persons who are in a “social graph belonging to user 101” and (b) for each person included in the determined set, using stored location information that is associated with the person in determining the recommended route.

As used herein, a “social graph belonging to user 101” is a set of persons who are directly or indirectly associated with user 101. As an example, persons directly associated with user 101 may include all persons that user 101 has identified as being a friend of user 101, and a person indirectly associated with user 101 may include friends of user 101's friends. As a particular example, if user 101 has a Facebook account, then the social graph belonging to user 101 may include all of persons who are Facebook “friends” with user 101, and, in some embodiments, user 101's social graph may further include all persons who are a Facebook friend with a Facebook friend of user 101. In yet other embodiments, if user 101 has a Twitter account, then user 101's social graph may also include all persons who are user 101's Twitter followers (i.e., are directly associated with user 101 on Twitter). In some embodiments, user 101's social graph may also include persons who share one more traits with user 101 (e.g., age, location, sex, marital status, income, hobbies, preferences). These persons are indirectly associated with user 101.

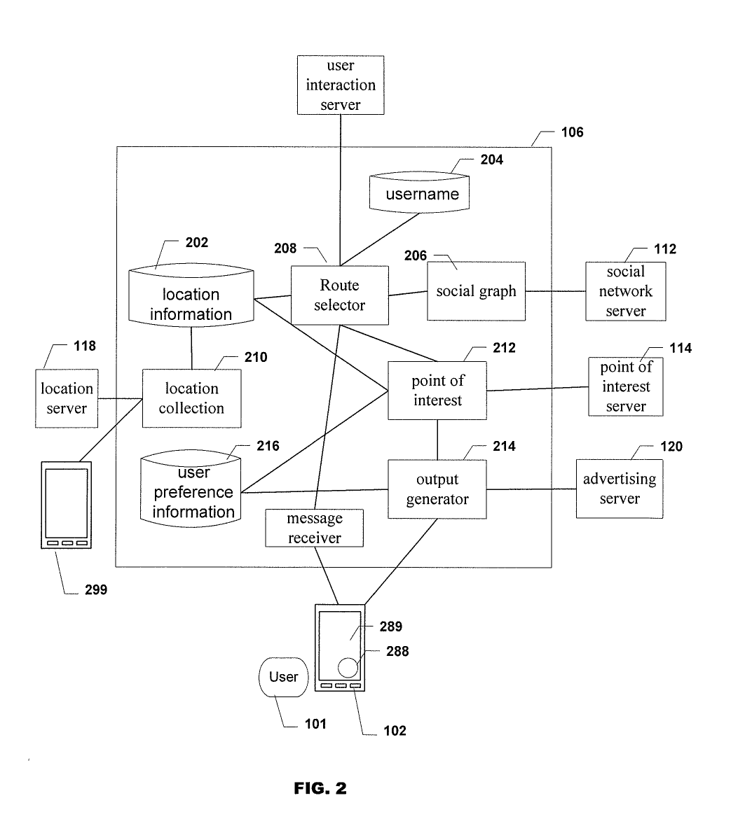

As a specific example, assume user 101 has sent to route recommender apparatus 106 a route request message 191 requesting a recommended route from user 101's apartment building to the nearest metro (or subway) stop. In response to receiving such a route request message 191, route recommender apparatus 106 may (a) determine persons who are Facebook friends with user 101, (b) for each such person, (b1) retrieve from a location information database 202 (see FIG. 2) location information associate with the person and (b2) use the retrieved location information to determine routes the person took in going from user 101's apartment building to the nearest metro stop, (c) use the routes determined in step (b2) to determine a recommended route, and (d) transmit to user 101 a route request response message 192 that includes route information identifying (directly or indirectly) the determined recommended route. In step (c), route recommender apparatus 106 may determine the recommended route by selecting the route that is taken most often (i.e., the most popular route), selecting the shortest route, or selecting the most popular route that passes by a coffee shop because route recommender apparatus 106 stores in a user preference information database 216 (see FIG. 2) preference information for user 101 that indicates that user 101 is a coffee lover.

Referring now to FIG. 2, FIG. 2 is a functional block diagram of an embodiment of route recommender apparatus 106. As illustrated in FIG. 2, route recommender apparatus 106 includes a message receiver 291 for receiving messages from user 101's communication device 102 (e.g. for receiving a route request message 191). In response to receiving a route request message 191 transmitted from user 101's communication device 101, message receiver 291 may pass to route selector 208 information identifying user 101 (e.g., a mobile identification number (MIN) of communication device 102), which information may have been included in route request message 191 and information identifying a starting location and an ending location between which user 101 is requesting a recommended route, which location information may also have been part of message 191.

Route selector 208 may use the information identifying user 101 to obtain one or more other user identifiers associated with user 101. For example, route selector 208 may use the information identifying user 101 to obtain user 101's user identifier and password for each of Facebook, Twitter, LinkedIn, etc. This information may be maintained in username database 204, which may include one or more tables mapping information identifying user 101 with a set of one or more user identifiers and passwords belonging to user 101 for external social networking systems.

The obtained user identifiers may then be used by a social graph module 206 to determine a social graph belonging to user 101. Social graph module 206 may determine at least a part of user 101's social graph by transmitting to an external social network server 112 (e.g., a Facebook server or a LinkedIn server) a request message for the purpose of obtaining from server 112 the identities (e.g., names or user identifiers) of people that are directly and indirectly associated with user 101. For instance, if server 112 is a Facebook server, then the request message may include user 101's Facebook user identifier and may request server 112 to transmit to social graph module 206 a response message containing a list of user 101's Facebook friends and a list of the people that are friends with user 101's Facebook friends.

In response to social graph module 206 determining user 101's social graph, or portion thereof, (i.e., determining persons that are directly or indirectly associated with user 101), route selector 208, for each person included in at least a subset of the persons that were determined to be directly or indirectly associated with user 101, obtains from location information database 202 location information associated with the person so that route selector 208 can determine routes the person has traversed.

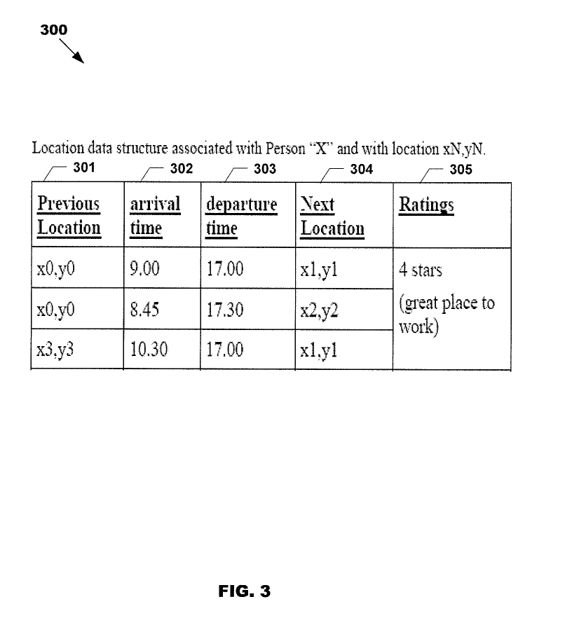

Referring now to FIG. 3, FIG. 3 illustrates a representative example location data structure 300 from location information database 202 that stores location information for a particular person (i.e. person X). More specifically, location data structure 300 stores person X's location information for a particular location—location xN, yN (e.g., person X's place of work). In the illustrated example, location data structure 300 is in the form of a table having a five columns. Each time person X arrives at location xN, yN, a row is added to table 300. This function may be performed by location collection module 210. Location collection module 210 may, at any point in time, request an external location server 118 to provide information identifying person X's current location. Location server 118 may be a location server operated by a mobile network operator. However, in some embodiments, location collection module may receive person X's current location from a device (e.g., device 299) that is carried by person X and that has the ability to determine person X's current location (e.g., device 299 may have a Global Positioning System (GPS) receiver).

In any event, location module 210 may be configured to periodically (e.g., every 5 minutes, 30 minutes, 2 hours, etc) obtain person X's (as well as a plurality of other persons') current location. If person X's current location has changed since the last time location module 210 determined person X's current location, then location module 210 may add a row to the table associated with person X's current location (and if such a table does not exist, location module 210 may create the table and add a row to the table). As shown in FIG. 3, a such a row may include the following fields: (1) a previous location field 301 for storing information identifying person X's previous location, (2) an arrival time field 302 for storing information identifying person X's arrival time at the current location, (3) a departure time field 303 for storing information identifying person X's departure time from the current location, (4) a next location field 304 for storing information identifying the location person X was found at after departing the current location, and (5) a rating information field 305 for storing information identifying a rating person X gave to the current location. For example, if the current location is a coffee shop, person X may rate the coffee shop using a rating application (e.g., Yelp).

Because location information database 202 may contain, for each of a plurality of persons, a table, like table 300, for each location the person visits or passes through, information database 202 contains information identifying routes that each of the plurality of persons has traversed. Thus, when user 101 requests a recommended route, route selector 208 can use information obtained from social graph module 206 (e.g., the list of user 101's “friends”) and from location information database 202 to determine routes traversed by user 101's friends. With this route information in hand, route selector 208 can perform any one of a variety of algorithms to determine a recommended route using, among other things, the obtained route information for the people within user 101's social graph. For example, in some embodiments, route selector 208 may use a well known “ant colony optimization (ACO)” algorithm.

After determining a recommended route, route selector 208 may provide information identifying the determined recommended route to point-of-interest module 214, which may be configured to determine recommended points-of-interest for user 101 that can be found on (or near) the determined recommended route. For example, using location information from location information database 202, point-of-interest module 214 may be able to determine that many of the people within user 101's social graph who traverse the recommended route regularly stop at a particular location on the route (e.g., a coffee shop). Additionally, point-of-interest module 214 may be able to determine from information stored in user preference information database 216 that user 101 is a coffee lover. Using this information, point-of-interest module 214 can be configured to conclude that the coffee shop is a recommended point-of-interest for user 101 and add to the information identifying the determined recommended route point-of-interest information for one or more of the recommended points-of-interest along the route.

In some embodiments, in response to determining that a particular location is a point-of-interest for user 101, point-of-interest module 214 may transmit to a point-of-interest server 114 a request message identifying the determined particular location and requesting information concerning the location. For example, if the location is a coffee shop, then point-of-interest server 114 may respond to the request message by transmitting to point-of-interest module 212 a response message containing information about the coffee shop (e.g., street address, hours of operation, phone number, web address, review information, or advertising). In response to receiving the information about the coffee shop, point-of-interest module 212 may add the information about the coffee shop to the information identifying the determined recommended route that was received from route selector 208. Point-of-interest module 212 may then pass the updated information identifying the determined recommended route to an output generator 214.

In response to receiving from point-of-interest module 212 the updated information identifying the determined recommended route, output generator 214 may request from an advertising server 120 an advertisement to include with the information received from point-of-interest module 212. Additionally, output generator 214 may be configured to obtain user 101's display preferences from user preference information database 216 and format the information received from point-of-interest module 212 is a display format preferred by user 101. Once the information received from point-of-interest module 212 (i.e., the information identifying the determined recommended route and any point-of-interest information) has been formatted, output generator 214 transmits to user 101's communication device 102 the route request response message 192 discussed above. After receiving route request response message 192, a route recommender application 288 executing on user 101's communication device 102 may display on a display 289 of communication device 102 a map with the determined recommended route and any of the points-of-interest determined by point-of-interest module 212 highlighted so that user 101 can easily see the recommended route and points-of-interest along that route.

In some embodiments, in response to a route request message, route selector 208 may determine a set of recommended routes instead of a single recommended route and the route request response message 192 may include, for each recommended route, route information identifying the determined recommended route.

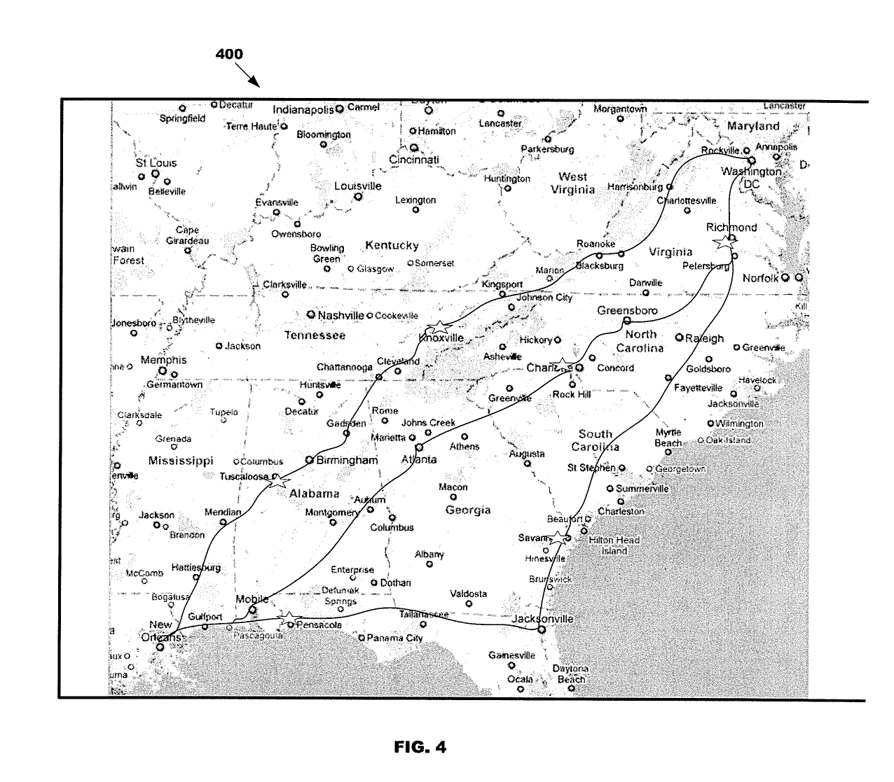

Referring now to FIG. 4, FIG. 4 illustrates an example user interface 400 that may be displayed on display 289 of user 101's communication device 102 in response to route recommender application 288 receiving a route request response message 192 that includes route information for each of a plurality of recommended routes determined by route recommender apparatus 106. In the example shown in FIG. 4, route recommender apparatus 106 has determined three recommended routes from point A (Washington, D.C.) to point B (New Orleans, La.). The star shaped objects represent determined points-of-interest. In some embodiments, user 101 can obtain information about a particular point-of-interest represented by one of the star shaped objects by selecting (e.g., clicking on or tapping) the star shaped object. This information about the particular point-of-interest may have been included in the route request response message 192.

In some embodiments, after route recommender apparatus 106, in response to a route request message 191 received from user 101's communication device 102, determines a set of one or more recommended routes and transmits a route request response message 192 to communication device 102, route recommender apparatus 106 may periodically (and automatically) update the set of recommended routes and transmit to communication device 102 updated route information. For example, after route recommender apparatus 106 determines an initial set of one or more recommended routes in response to receiving a route request message 191, route recommender apparatus 106 may periodically determine whether routes should be added and/or removed from the initial set of recommended routes and also whether points-of-interest should be added and/or removed from a route included in the initial set of recommended routes.

For example, if route recommender apparatus 106, based on location information from location information database 202, determines that one of the routes that was initially recommended is no longer being used by user 101's friends (or is being used only infrequently), the route recommender apparatus 106, in response to this determination, may transmit to communication device 102 a message indicating that the route is no longer a recommended route. As another example, if route recommender apparatus 106, based on location information from location information database 202, determines that at least a certain percentage of the persons in user 101's social graph who traverse a route included in the initial set of routes stop at a new location located on the route, then route recommender apparatus 106, in response to this determination, may transmit to communication device 102 a message indicating that the route has a new point-of-interest and including information pertaining to this new point of interest (e.g., its location, among other things) so that when user 101 uses route recommender application 288 to view the route, route recommender application 288 can display on the route a star shaped object correspond to the newly discovered point of interest.

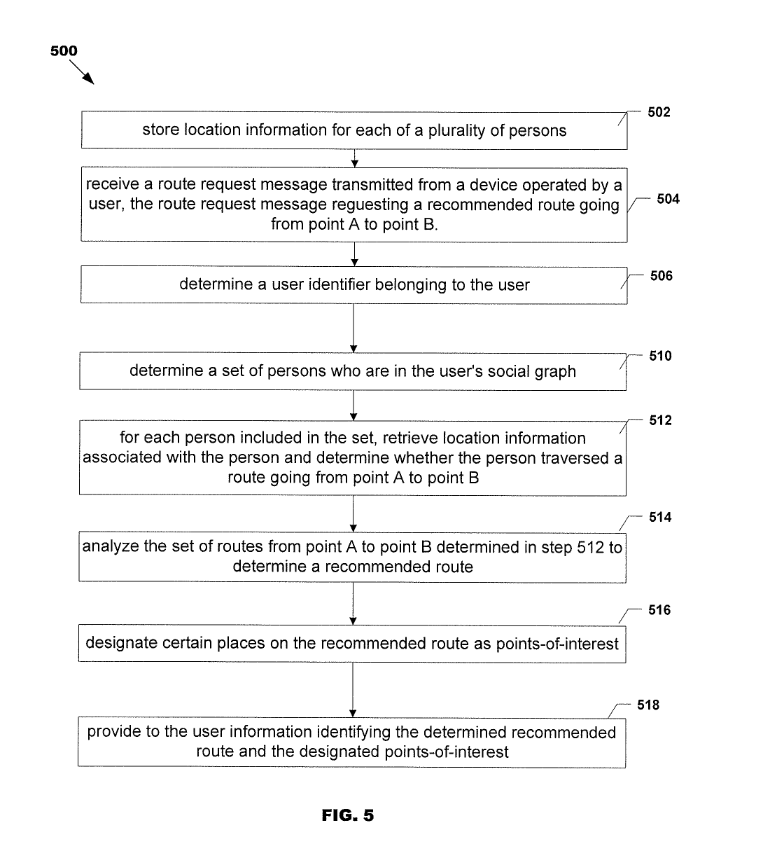

Referring now to FIG. 5, FIG. 5 is a flow chart illustrating a process 500, according to an embodiment, that may be performed by route recommender apparatus 106. Process 500 may begin in step 502, where route recommender apparatus 106 stores in location information database 202 location information for each of a plurality of persons. We shall assume that each of the plurality of persons has consented to route recommender apparatus 106 collecting, storing, and using this personal location information. As discussed above, route recommender apparatus 106 may include a location collection module 210 for performing this function.

In step 504, route recommender apparatus 106 receives from user 101's communication device 102 a route request message 191. The route request message identifies a starting location and an ending location and requests a recommended route from the starting location to the ending location.

In step 506, route recommender apparatus 106 determines a user identifier for user 101. For example, route recommender apparatus 106 may determine the MN of communication device 102 or the route request message 191 itself may contain the user identifier for user 101.

In step 510, route recommender apparatus 106 uses the user identifier determined in step 506 to determine a set of persons who are in user 101's social graph. As described above, route recommender apparatus 106 may include a username database that maps the user identifier determined in step 506 with a set of one or more other user identifiers (e.g., user 101's Facebook user identifier) that can be used to obtain a list of persons who are directly or indirectly associated with user 101.

In step 512, for each person included in the set of persons determined in step 510, route recommender apparatus 106 retrieves location information associated with the person and, using the retrieved location information, determines whether the person traversed a route going from the starting location to the ending location. That is, in step 512, route recommender apparatus 106 determines a set of routes going from the starting location to the ending location, where each route in the set was traversed by at least one of the persons included in the set of persons determined in step 510.

In some embodiments, in step 512, route recommender apparatus 106 takes into account the current time of day and the times that the determined routes were traversed. For example, in some embodiments, route recommender apparatus 106 includes in the determined set of routes only those routes that were traversed at about the same time of day as when the route request message was received. So, for example, if the route request message is received in the morning, route recommender apparatus 106 will include in the set of determined routes only those routes that were traversed in the morning time. As illustrated in FIG. 3, location information database 202 stores time information from which one may determine the time a particular person traversed a particular route.

In step 514, route recommender apparatus 106 analyzes the set of routes from the starting location to the ending location determined in step 512 to determine a set of one or more recommended routes.

In step 516, route recommender apparatus 106 designates certain places on a recommended route as points-of-interest

In step 518, route recommender apparatus 106 provides to user 101 (e.g., transmits to user 101's communication device 102) information identifying the determined recommended route(s) and the designated points-of-interest.

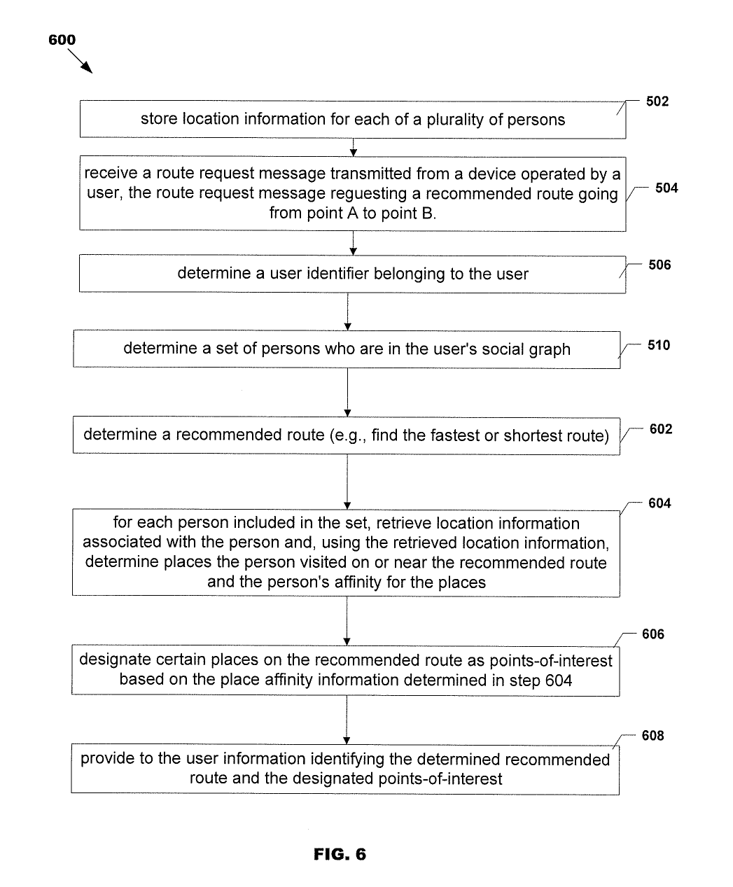

Referring now to FIG. 6, FIG. 6 is a flow chart illustrating a process 600, according to an embodiment, that may be performed by route recommender apparatus 106. As shown, the first four steps of process 600 are the same as the first four steps of process 500. That is, process 600 may being with step 502 and proceed to steps 504, 506 and 510, which steps are described above.

In step 602, route recommender apparatus 106 determines a recommended route going from the starting location to the ending location. For example, in step 602, route recommender apparatus 106 may use conventional algorithms to determine the fastest or shortest route from the starting location to the ending location.

In step 604, for each person included in the set of persons determined in step 510, route recommender apparatus 106 retrieves location information associated with the person and, using the retrieved location information, determines places the person has visited on or near the determined recommended route and the person's affinity (i.e., liking) for the place. There are several way that route recommender apparatus 106 can determine the person's affinity for a place. First, if the person has rated the place (e.g., given the place four out four stars), then route recommender apparatus 106 can determine the person's affinity simply by determining the rating the person gave to the place. Another way route recommender apparatus 106 can determine the person' affinity for a place is to determine how often the person has visited the place within some arbitrary period of time (e.g., the last six months). If the person visits the place every day, that is an indication that the person has a high liking for (i.e., affinity for) the place, whereas if the person visited the place only once and never returned, then that is an indication that the person has no or low affinity for the place.

In step 606, route recommender apparatus 106 designates certain places on the recommended route as points-of-interest based on the place affinity information determined in step 604. For example, if route recommender apparatus 106 determines that several of the people within user 101's social graph have a high affinity for a place that is on or near the recommended route, then route recommender apparatus 106 may designate that place as a point-of-interest.

In step 608, route recommender apparatus 106 provides to user 101 (e.g., transmits to user 101's communication device 102) information identifying the determined recommended route(s) and the designated points-of-interest.

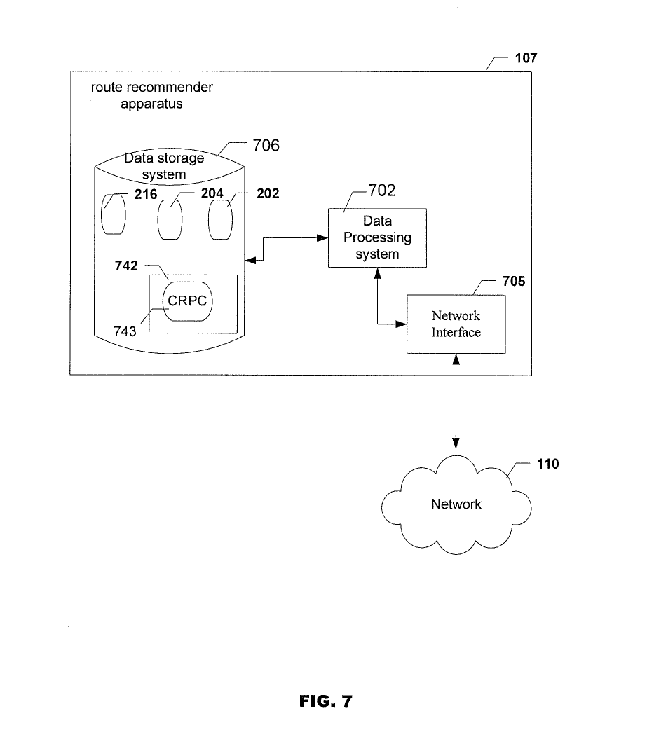

Referring now to FIG. 7, FIG. 7 illustrates a block diagram of route recommender apparatus 106 according to some embodiments of the invention. As shown in FIG. 7, route recommender apparatus 106 may include: a data processing system 702, which may include one or more microprocessors and/or one or more circuits, such as an application specific integrated circuit (ASIC), Field-programmable gate arrays (FPGAs), etc; a network interface 705 for receiving messages (e.g., route request messages 191 transmitted from a communication device 102); data storage system 706, which may include one or more non-volatile storage devices and/or one or more volatile storage devices (e.g., random access memory (RAM)). As shown, data storage system 706 may be used to store location information database 202, user preference information database 216 and username database 204. In embodiments where data processing system 702 includes a microprocessor, computer readable program code 743 may be stored in a computer readable medium 742, such as, but not limited, to magnetic media (e.g., a hard disk), optical media (e.g., a DVD), memory devices (e.g., random access memory), etc. In some embodiments, computer readable program code 743 is configured such that when executed by a processor, code 743 causes route recommender apparatus 106 to perform steps described above (e.g., steps describe above with reference to the flow chart shown in FIGS. 5). In other embodiments, route recommender apparatus 106 is configured to perform steps described above without the need for code 743. That is, for example, data processing system 702 may consist merely of one or more ASICs. Hence, the features of the present invention described above may be implemented in hardware and/or software. For example, in particular embodiments, the functional components of route recommender apparatus 106 described above may be implemented by data processing system 702 executing computer instructions 743, by data processing system 702 operating independent of any computer instructions 743, or by any suitable combination of hardware and/or software.

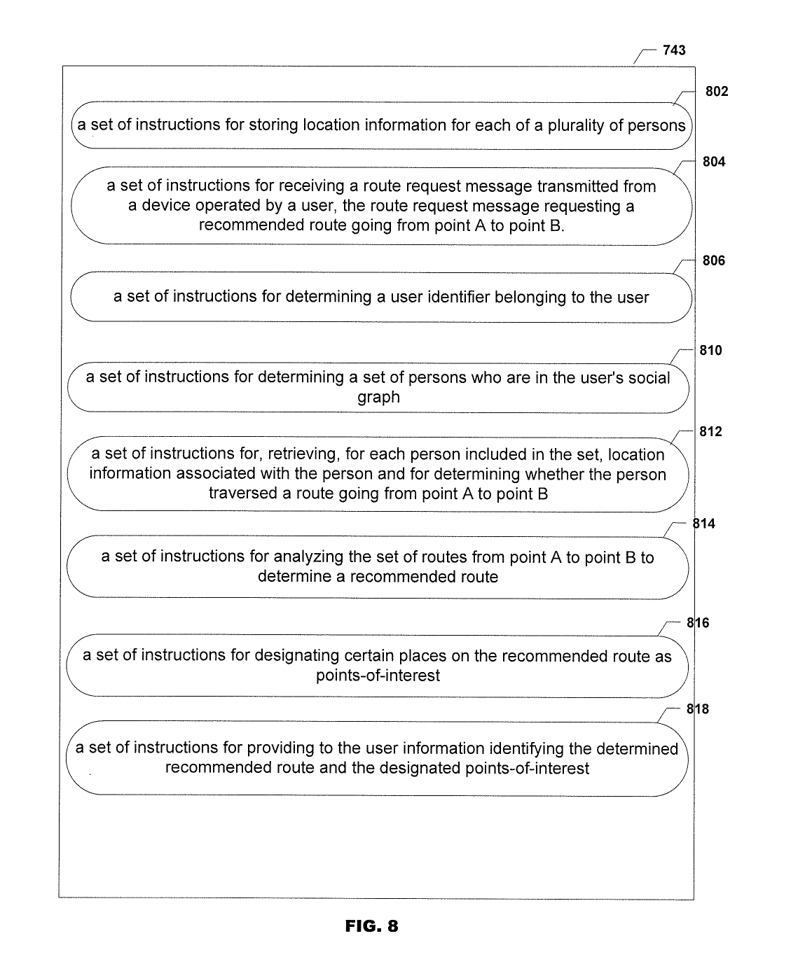

Referring now to FIG. 8, FIG. 8 illustrates an embodiment of computer readable program code (CRPC) 743. In the embodiment shown, CRPC 743 includes: (1) a set of instructions 802 for storing location information for each of a plurality of persons, (2) a set of instructions 804 for receiving a route request message transmitted from a device operated by a user, the route request message requesting a recommended route going from point A to point B, (3) a set of instructions 806 for determining a user identifier belonging to the user, (4) a set of instructions 810 for using the determined user identifier to determine a set of persons who are in the user's social graph, (5) a set of instructions 812 for retrieving, for each person included in the set, location information associated with the person and for determining whether the person traversed a route going from point A to point B (i.e., instructions for determining a set of routes going from point A to point B, where each route in the set was traversed by at least one of the persons included in the set of persons), (6) a set of instructions 814 for analyzing the determined set of routes from point A to point B to determine a recommended route, (7) a set of instructions 816 for designating certain places on the determined recommended route as places-of-interest, (8) a set of instructions 818 for providing to the user information identifying the determined recommended route and the designated points-of-interest.

### ADDITIONAL EXAMPLE

Johan is a trucker who recently started to drive from Washington to New Orleans. Johan is Facebook friends with five other truckers, who also travel from Washington to New Orleans. Let us assume there are 50 different possible routes from Washington to New Orleans, all of equal convenience. Hence, each of the five friends may take different routes every time they go from Washington to New Orleans (and back). Johan wants to find the most interesting route to go from Washington to New Orleans, and where the best coffee is along the route. Johan, therefore, sends a route request message 191 to route recommender apparatus 106. In response, route recommender apparatus 106 determines Johan's Facebook friends and the routes these friends have taken from Washington to New Orleans over the past few months (an arbitrary, but user-definable, period). Route recommender apparatus 106 then collates the instances of the different routes that the five trucker friends have taken over the period of time, and the instances when they have stopped at a location. The frequency of the routes taken and the locations stopped at are used to determine a recommended route and points-of-interest along the route. Locations where a friend made a note may be given an additional weight. After determining a recommended route and points-of-interest, route recommender apparatus 106 may then transmit to point-of-interest server 114 a request message identifying the determined point-of-interests and requesting information concerning these locations. After route recommender apparatus 106 receives a response from server 114, route recommender apparatus 106 then generates a route request response message 192 that will include information identifying the determined recommended route(s) and information pertaining to the determined points-of-interest, and transmits the response message to Johan. The response message may further include information identifying the times of day when Johan's friends typically depart Washington for New Orleans. In response to receiving the route request response message, Johan's communication device may display the recommended route(s) and recommended points-of-interest on a map as shown in FIG. 4.

When Johan wants to go to New Orleans, Johan may leave at the time of day indicated in the response message and follow the recommended route. Johan may stop for a coffee at places that one of his friends has rated highly. Hence, the probability that Johan will meet a friend while traversing the recommended route is greater than if Johan selected one of the 50 routes at random, and the probability that Johan will get better coffee than otherwise is also larger.

While various embodiments of the present invention have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A route recommendation apparatus for recommending a route to a user, comprising:
a data storage system for storing, for each of a plurality of persons, location information associated with the person, the location information comprising information identifying places that the person has previously visited or passed through;
a network interface for receiving route request messages; and
a data processing system configured to perform a method in response to the network interface receiving a route request message that was transmitted by a communication device operated by a user, where the route request message requests a recommended route from a first location to a second location, the method comprising:
determining a recommended route going from the first location to the second location, wherein the determining step comprises using at least some of the stored location information in determining the recommended route; and
using the network interface to transmit to the communication device a route request response message comprising information identifying the determined recommended route.

2. The apparatus of claim 1, wherein
the method further comprises determining a set of persons who are in a social graph belonging to the user; and
the step of using at least some of the stored location information in determining the recommended route comprises using only stored location information that is associated with a person who is in the user's social graph in determining the recommended route.

3. The apparatus of claim 1, wherein the location information associated with one of the plurality of persons includes information identifying places the person has previously visited.

4. The apparatus of claim 3, wherein the location information associated with the one of the plurality of persons further comprises rating information identifying a rating said person gave to one of the places.

5. The apparatus of claim 4, wherein the step of using at least some of the stored location information in determining the recommended route comprises using information identifying a route going from the first location to the second location traversed by said person and said rating information.

6. The apparatus of claim 1, wherein the location information associated with one of the plurality of persons further comprises time information identifying a time of day at which said person traversed a route going from the first location to the second location.

7. The apparatus of claim 6, wherein
the method comprises determining the current time of day; and
the step of using at least some of the stored location information in determining the recommended route comprises using said time information and said determined current time of day in determining the recommended route.

8. The apparatus of claim 1, wherein
the data storage system is operable to store preference information belonging to the user; and
the step of determining the recommended route further comprises using the preference information in determining the recommended route.

9. The apparatus of claim 1, wherein
the information identifying the determined recommended route comprises information identifying recommended places to visit.

10. The apparatus of claim 9, wherein
the information identifying recommended places to visit includes information identifying a rating one of the plurality of persons gave to the one of the recommended places to visit.

11. A route recommendation method for recommending a route to a user, comprising:
for each of a plurality of persons, storing location information associated with the person, the location information comprising information identifying places that the person has previously visited or passed through;
receiving, at a server, a route request message transmitted from a communication device operated by the user, the route request message requesting a recommended route from a first location to a second location;
in response to receiving to receiving the route request message, determining a recommended route going from the first location to the second location, wherein the determining step comprises using at least some of the stored location information in determining the recommended route; and
transmitting, from the server and to the communication device, a route request response message comprising information identifying the determined recommended route.

12. The method of claim 11, wherein
the method further comprises determining a set of persons who are in a social graph belonging to the user; and
the step of using at least some of the stored location information in determining the recommended route comprises using only stored location information that is associated with a person who is in the user's social graph in determining the recommended route.

13. The method of claim 11, wherein the location information associated with one of the plurality of persons comprises information identifying places the person visited.

14. The method of claim 13, wherein the location information associated with the one of the plurality of persons further comprises rating information identifying a rating said person gave to one of the places.

15. The method of claim 14, wherein the step of using at least some of the stored location information in determining the recommended route comprises using information identifying a route going from the first location to the second location traversed by said person and said rating information.

16. The method of claim 11, wherein the location information associated with one of the plurality of persons further comprises time information identifying a time of day at which said person traversed said route.

17. The method of claim 16, wherein
the method further comprises determining the current time of day; and
the step of using at least some of the stored location information in determining the recommended route comprises using said time information and said determined current time of day in determining the recommended route.

18. The method of claim 11, wherein
the method further comprises storing preference information belonging to the user; and
the step of determining the recommended route further comprises using the preference information in determining the recommended route.

19. The method of claim 11, wherein
the information identifying the determined recommended route comprises information identifying recommended places to visit.

20. The method of claim 19, wherein
the information identifying recommended places to visit includes information identifying a rating one of the plurality of persons gave to the one of the recommended places to visit.
